(19) United States
(12) Patent Application Publication
(10) Pub. No.: US 2009/0147684 A1
(43) Pub. Date: Jun. 11, 2009

(54) Dynamic, integrated, multi-service network cross-layer optimization

(76) Inventor: Reza Majidi-Ahy, Los Altos, CA (US)

Correspondence Address: Reza Majidi-Ahy, 1225 Eva Ave, Los Altos, CA, 94024, US

(21) Appl. No.: 12/001,090

(22) Filed: Dec. 10, 2007

(51) Int. Cl. G08C 15/00; H04J 3/22

(52) U.S. Cl. 370/236; 370/237; 370/329; 370/469

(57) ABSTRACT

The integrated network optimization as a comprehensive framework for a multi-variable optimization across all seven layers of the OSI model, of the network resources and their allocations to optimally enable services to the end-users based on their service level agreements (SLAs), in particular but not limited to wireless networks.

This approach is real-time and thus dynamically in an integrated fashion allocates the resources of the network in an optimal manner to the many users on the network simultaneously such that the nature and requirements of each application, each user is using are addressed.

This invention optimizes the utilization of resources & spectrum of the network, the quality of the experience of the users of the network, the quality of the applications and services delivered by the network to the users, the economics of the network & its operation by optimal utilization of the resources for wireless networks.

### RELATED APPLICATIONS

The present application is related to U.S. Pat. No. 7,016,668, issued Mar. 21, 2006, for METHOD AND APPARATUS FOR A RECONFIGURABLE MULTI-MEDIA SYSTEM, by Krishnamurthy Vaidyanathan, Santhana Krishnamachari, Mihaela VanderSchaar, included by reference herein.

The present application is related to U.S. patent number 20020054578, issued May 9, 2002, for CHANNEL AND QUALITY OF SERVICE ADAPTATION FOR MULTIMEDIA OVER WIRELESS NETWORKS, by Zhang, Qian; (Hubei, C N); Zhu, Wenwu; (Basking Ridge, N J); Zhang, Ya-Qin; (West Windsor, N J); Wang, Guijin; (Beijing, C N), included by reference herein.

The present application is related to U.S. Pat. No. 6,578,085, issued Jun. 10, 2003, for SYSTEM AND METHOD FOR ROUTE OPTIMIZATION IN A WIRELESS INTERNET PROTOCOL NETWORK, by Mohamed M. Khalil, Emad Q. Qaddoura, Haseeb Akhtar, Liem Le, included by reference herein.

The present application is related to U.S. Pat. No. 7,184,420, issued Feb. 27, 2007, for METHOD FOR DYNAMICALLY LOCATING A WIRELESS TCP PROXY IN A WIRED/WIRELESS, by Jiyeon Son, Ji Eun Kim, Jun Seok Park, Dong Won Han, Chae Kyu Kim, included by reference herein.

The present application is related to U.S. Pat. No. 6,862,622, issued Mar. 1, 2005, for TRANSMISSION CONTROL PROTOCOL/INTERNET PROTOCOL (TCP/IP) PACKET-CENTRIC, by Jacob W. Jorgensen, included by reference herein.

The present application is related to U.S. Pat. No. 6,937,562, issued Aug. 30, 2005, for APPLICATION SPECIFIC TRAFFIC OPTIMIZATION IN A WIRELESS LINK, by Kevin L. Farley; James A. Proctor, Jr, included by reference herein.

The present application is related to U.S. Pat. No. 6,519,462, issued Feb. 11, 2003, for METHOD AND APPARATUS FOR MULTI-USER RESOURCE MANAGEMENT IN WIRELESS, by Ming Lu, Ashok N. Rudrapatna, Pengfei Zhu, included by reference herein.

### FIELD OF THE INVENTION

The present invention relates to IP networks and, more particularly, to cross-layer optimization of the network resources for best delivery of the applications and services. This is in particular critical for wireless networks.

### BACKGROUND OF THE INVENTION

1. Overview

Networks today (private, public, enterprise or carrier) are migrating towards supporting multiple types of applications to a multitude of end-users with very different requirements simultaneously. This applies to all types of networks inclusive of mobile, portable, and fixed networks.

Most recently there is a major trends for almost all networks, inclusive of mobile, portable, and fixed networks, to be based on the Internet Protocol (IP). The IP-based networks are packet-based and traditionally follow a model commonly known as the seven-layer OSI model.

In traditional IP networks each of these seven layers are considered independent and the corresponding architecture and requirements are specific to that layer only. As the speed of the transmissions increase and in the broadband networks however the attributes of these layers start to increasingly affect each other.

In wireless IP networks in particular the broadband nature of the transmissions and the increasingly demanding applications in terms of bandwidth and the quality-of-service (QoS), result in the increasingly significant interdependencies between these seven layers in particular for efficient network operations and effective use of the precious wireless spectrum.

This patent describes a novel integrated approach in the optimization of the IP network parameters and resources such that the result would be a fundamentally and substantially more efficient and effective network.

2. Dynamic Networks

The traffic in the networks are dynamic and unpredictable as they correspond to the one or more applications being used by each of a multitude of end-users with different service-level agreements and requirements. In IP Multi-Service Networks in particular the dynamic nature of requirements for each user of a multitude of users, as a result of time-dependent multiple applications used per user, imposes significant demand for optimal allocation of network resources, the mapping of the SLA's and the policies onto the algorithms for the resource allocations, and the optimization of these based on the applications & their respective traffic: all as a function of time and dynamically.

3. Multi-Application IP-based Networks

In the current IP Networks and the Next Generation IP-based Networks (inclusive of fixed NGNs, Portable NGNs, and mobile NGNs), there are many different applications with different requirements present simultaneously as part of the traffic. The most basic types of applications are VoIP, Video-o-IP & data. The table in section 5 below provides the requirements for the three basic applications.

In addition to these basic services other applications are increasingly becoming more popular with the end-user include the following:
Video Telephony
Gaming
Streaming Video Multicast
IPTV
Multimedia-Web-Sites Access
Multimedia-Rich emails
Multimedia-Rich File Transfers

4. Multi-User Networks

The IP-based Networks normally serve a multitude of users simultaneously. Depending on the part or the type of the network the number of simultaneous users can range from tens of users to millions of users. For example the access networks typically have tens to hundreds of simultaneous users. At the edge of the network, defined as the point of aggregation for the backhaul network which as the name indicates connects multiple access nodes (base stations in the case of wireless carrier networks), thousands of users are covered, and at the core of the network where the policy functions and the user profiles are typically managed, the number of simultaneous users could be up to hundreds of thousands or even millions.

For the next generation IP-based networks the optimization of the network resources become vital because the applications are becoming more demanding in terms of the network resources (inclusive of the bandwidth and QoS parameters . . . ), the number of applications per user is on the rise (for example VoIP is now becoming more prevalent in addition to data-o-IP, and soon video-o-IP), and the percentage of users actively and increasingly utilizing these media-rich applications is also on the rise.

5. Multi-SLA Networks

Service providers or Carriers typically sell Service Level Agreements that describes key parameters of the service including the bandwidth, Class-of-Service (CoS), and other QoS parameters. In particular for the users of the premium services of a carrier, i.e. those higher paying end-users such as the businesses, these SLAs often constitute as part of their IT infrastructure, and thus often vital to their business transactions (including VoIP, Video Conferencing, CBR data . . . ).

In a major operator network typically there is a broad spectrum of SLAs or sensitivity to the SLAs, corresponding to a broad spectrum of end-user profiles constituting a multi-SLA network.

6. Application-Specific Network Requirements

The most basic types of applications are VoIP, Video-o-IP & data. The table below provides the requirements for these three basic applications.

Application Rate Required Burstiness PER Delay Sensitivity Jitter Sensitivity

Voice-o-IP 8-64 Kbps Medium<10-2 High High Video-o-IP 64-6,000 Kbps Low<10-4 Medium Medium Data 250-20,000 Kbps High<10-6 CBR: High CIR: Medium BE: Low CBR: High CIR: Medium BE: Low

(PER=Packet Error Rate, CBR=Constant Bit Rate, CIR=Committed Information Rate, BE=Best Effort)

A major carrier typically includes some of these parameter as part of the SLA it sells to the end-user. For example business end-users, such as enterprise or SME, typically subscribe to high quality VoIP (such as CIR VoIP), high-quality data (such as CBR or CIR data), in addition to the bandwidth requirement (such as a T1 equivalent: 1-2 Mbps).

7. Session-Specific Networks Requirements

In a wireless network as the end-user roams between the base stations or the access point, for mobile and portable both, the continuity of the session becomes a significant aspect of service delivery in particular for time-bounded applications such as VoIP and Video-o-IP with sensitivity to delays, jitter, and packet loss in addition to the bandwidth. An integrated Optimization framework involving all seven OSI layers or a subset of them is a fundamental approach to significantly enhance session continuity in multiple scenarios inclusive of the roaming end-user or across multiple end-user devices.

8. Wireless Networks

In a wireless network the traffic for multiple users associated with a base station is unpredictable and dynamic given that the application or the multiple applications (Voice, email, web-access, . . . ) for the same user are unpredictable and dynamic, the usage behavior and model of the multiple users group or ensemble is dynamic, and the traffic pattern for each of these applications is also often dynamic. In a real multiple base stations scenario (as typically seen by an access network gateway) for a network the aggregated traffic from these base stations also has a time-varying contribution from each. In a real multiple access network gateways scenario (as typically seen by an core network gateway) for a network the aggregated traffic from these access network gateways also has a time-varying contribution from each.

In wireless mobile and portable (as opposed to fixed such as WiMAX-802.16d) networks, the end-users roam between different base stations. The roaming and the hand-over between the base stations add another independent dimension of dynamic and nearly unpredictable characteristic to these wireless networks.

Therefore as in the example of the wireless network above, there is a time-varying dynamic & unpredictable pattern for each level of the network from the end-user to the core. In a broadband wireless IP-based network (such as WiMAX, 3G, 3.5G and 4G) in particular, there is also the airlink (i.e. the link between the base station and the end-user terminal), which is also quite dynamic due to multipath and external interference. In these networks typically there is an algorithm called link adaptation, which adjusts the airlink parameters for a particular objective. However in general even with link adaptation configured for the maximum predictability of the airlink, there is an inherent fundamental dynamic nature to this link. Therefore the wireless broadband networks in particular typically have this dynamic characteristic the most.

9. Access Networks

These networks are typically defined as those providing the link to the end-user. In the case of mobile and portable wireless networks the end-user terminal (such as a handheld or a laptop) is one end and the other end is the base station. In the case of the fixed or multi-tier wireless access networks (such as WiMAX-WiFi or 3G-WiFi heterogeneous 2-tier wireless networks), the end-user is actually connected to the underlay wireless networks but the dynamic characteristics described are applicable in all tiers of these networks typically.

The access networks are typically now managed by an access gateway (such as SGSN in the case of the 3GPP, PDSN in the case of the 3GPP2, and ASN-GW in the case of WiMAX-Mobile).

10. Core Networks

These access gateways are typically now managed by a core gateway (such as GGSN in the case of the 3GPP and CSN-GW in the case of WiMAX-Mobile). The core networks typically include the home agent (HA), the policy functions and the user profiles (inclusive of their SLAs) database.

11. Dynamic Integrated, Multi-Service Network Cross-Layer Optimization

The integrated network optimization is a comprehensive framework for a multi-variable optimization across all seven layers of the OSI model, of the network resources and their allocations to optimally enable services to the end-users based on their SLAs.

The integrated network optimization as a comprehensive framework for a multi-variable optimization across all seven layers of the OSI model, of the network resources and their allocations to optimally enable services to the end-users based on their service level agreements (SLAs), in particular but not limited to wireless networks.

This approach is real-time and thus dynamically in an integrated fashion allocates the resources of the network in an optimal manner to the many users on the network simultaneously such that the nature and requirements of each application, each user is using are addressed.

This invention optimizes the utilization of resources & spectrum of the network, the quality of the experience of the users of the network, the quality of the applications and services delivered by the network to the users, the economics of the network & its operation by optimal utilization of the resources for wireless networks.

In U.S. Pat. No. 7,016,668 a reconfigurable multi-media system, method and device provides monitoring and reconfiguration of a plurality of communication layers of a communications stack to dynamically reconfigure the modulation and coding of software defined radio (SDR). The system includes a software object radio (SWR) library having reconfigurable object specification, design and performance parameters, the SWR is adapted for at least one of transmitting and receiving multi-media content via wireless communication; a controller in communication with the SWR library; a power management device module in communication with said controller; a reconfigurable encoder/decoder in communication with said controller to provide the SWR with dynamic coding information for modulation; a TCP/IP interface in communication with said reconfigurable encoder/decoder and said controller; and an application layer comprising a link layer and a reconfigurable physical layer in communication with each other and said controller, . . . .

In patent number 20020054578 a cross-layer architecture is provided for delivering multiple media streams over 3G W-CDMA channels in adaptive multimedia wireless networks. A resource management mechanism dynamically allocates resources among different media streams adapted to channel status and Quality of Service (QoS) requirements. By taking the time-varying wireless transmission characteristics into account, an allocation of resources is performed based on a minimum-distortion or minimum-power criterion. Estimates of the time-varying wireless transmission conditions are made through measurements of throughput and error rate. Power and distortion minimized bit allocation schemes are used with the estimated wireless transmission conditions to for dynamically adaptations in transmissions.

In U.S. Pat. No. 6,519,462 a method and apparatus are provided for dynamically controlling a high speed wireless communication system to optimize utilization of system resources and thereby increase system throughput. The invention operates to determine an allocation of wireless transmission resources to each user application served by the wireless system in a manner to optimize transmission resources while meeting required Qos criteria for the served user application. After all user applications have been provided a transmission resource allocation in this manner, the total transmission resources so allocated are determined and compared with a ceiling transmission resource level for the wireless system. A portion of the difference between the ceiling and currently allocated transmission resource levels is then made available, according to the invention, to the served user applications in proportion to the initial allocation provided each user application.

In U.S. Pat. No. 7,016,668 specifically the TCP/IP interacts with the encoder/decoder and the reconfigurable physical layer, and an integrated cross layer approach encompassing as many layer as possible for the optimization of the multi-service network is not used. Therefore the optimization is specifically limited to the encoder/decoder for the multimedia delivery.

In patent number 20020054578 specifically the crosslayer architecture is designed for 3G W-CDMA channels which is not inherently native IP (Internet protocol). Also not all the payers in the 7-layer OSI model are utilized. Therefore this prior art is limited to 3G W-CDMA and also optimization for minimum-distortion and minimum-power as opposed to an integrated all-encompassing approach.

In U.S. Pat. No. 6,519,462 the crosslayer optimization and an integrated approach is not used for resource allocation.

It is therefore an object of the invention to optimize the utilization of resources of the network.

It is another object of the invention to optimize the quality of the experience of the users of the network.

It is another object of the invention to maximize the effective utilization of the spectrum for wireless networks

It is another object of the invention to optimize the quality of the applications and services delivered by the network to the users.

It is another object of the invention to optimize the economics of the network & its operation by optimal utilization of the resources for wireless networks

### SUMMARY OF THE INVENTION

In accordance with the present invention, there is provided the integrated network optimization as a comprehensive framework for a multi-variable optimization across all seven layers of the OSI model, of the network resources and their allocations to optimally enable services to the end-users based on their service level agreements (SLAs).

This approach is real-time and thus dynamically in an integrated fashion allocates the resources of the network in an optimal manner to the many users on the network simultaneously such that the nature and requirements of each application, each user is using are addressed. Therefore the end result is a superior experience for the users and more efficient use of network resource.

The integrated network optimization is a comprehensive framework for a multi-variable optimization across all seven layers of the OSI model, of the network resources and their allocations to optimally enable services to the end-users based on their SLAs.

Therefore the application layer (layer 7) provides the application-specific requirements as constrained by the specific end-user profile and SLA.

The presentation layer (layer 6), provides the compression & SLA-specific encryption as in section 6 as constrained by the specific end-user profile and SLA, as well as the compression algorithm and parameters as required for the delivery of the service and network optimization within the SLA range.

The session layer (layer 5), provides the session setup, initiation and continuity, & the SLA-specific mobility and portability as constrained by the specific end-user profile and SLA, as well as the session continuity algorithms and parameters as required for the delivery of the service and network optimization within the SLA range, and as the end-user is in the portable or mobile mode.

The transport layer (layer 4) provides the transport protocol optimization, control of the flows, and minimization of the congestions and distortions as required for the delivery of the service and network optimization within the SLA range.

The network layer (layer 3) provides the QoS parameters optimization, as well as IP-Routing optimization for congestion and wireless channel degradation (as applicable) as required for the delivery of the service and network optimization within the SLA range.

The MAC layer (layer 2), provides the QoS parameters optimization per the SLA, in scheduling the traffic, as well as physical layer interfacing optimization for congestion and wireless channel degradation (as applicable) inclusive of partial link adaptation parameters optimization, as required for the delivery of the service and network optimization within the SLA range.

The PHY layer (layer 1) provides the partial link adaptation parameters optimization (such as adaptive modulation and coding, multi-antenna algorithms.), as well as MAC layer interfacing optimization for and wireless channel degradation (as applicable) as required for the delivery of the service and network optimization within the SLA range.

In a traditional IP network (such as a data-oriented wireline network), the 7 layers of the OSI model are independent addressing the different functions performed. In a broadband wireless network however there is increasing need for coupling and feedback between the different layers of the OSI model. The joint MAC-PHY layers optimization is now largely adopted in the broadband wireless IP networks standardization such as WiMAX and 3GPP.

With multiple services (multi-tier VoIP, Video-o-IP, Data,) over the broadband wireless IP networks, the need for these interactions between the various OSI layers for an effective and efficient IP network with substantial multimedia traffic increases substantially.

An Integrated approach to Optimization involving all seven layers or a subset, for robust and resilient, high quality IP-based multimedia communication in a real-world network is the subject matter of this patent application. In a real-world network the links between the end-users and the access network node (Base stations) compete for the network resources. Specifically in a single base station area of coverage a multitude of end-users in the presence of varying multipath and interference compete for the network resources for that base station. In a real-world multi-base station the end-users associated with one base station also compete for network resources with the end-users of other base stations as well.

At the core of the network the SLA-based delivery of the services (multiple to each end-user) requires management and optimization all the network resources. The Dynamic Integrated Multi-Service Network Optimization is the framework leveraging the capabilities of all seven layers of the OSI model by fully exploiting the feedback and the interaction amongst these layers to achieve drastically improved levels of optimization.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a seven layers of the osi model and the respective functions; and

FIG. 2 is a bottom detail view of a cross-layer interactions and feedback between all osi mode seven layers for the optimization of the network, services, applications and user quality-of-experience.

For purposes of clarity and brevity, like elements and components will bear the same designations and numbering throughout the Figures.

### DESCRIPTION OF THE PREFERRED EMBODIMENT

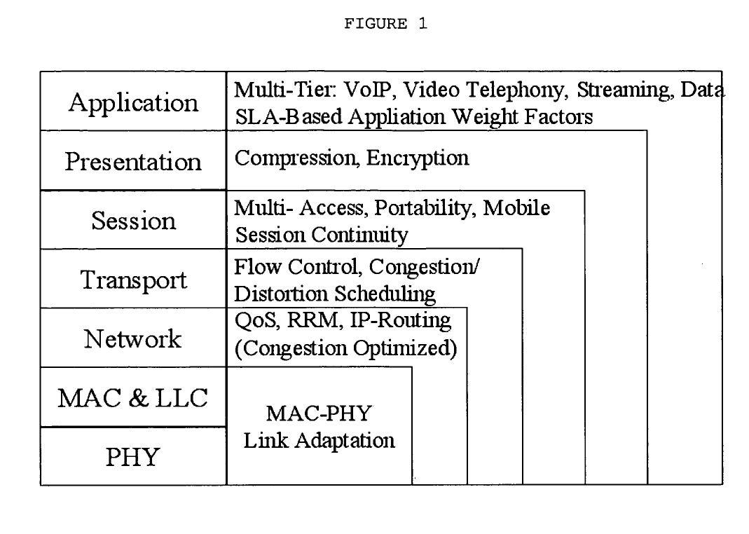

FIG. 1 is a seven layers of the osi model and the respective functions.

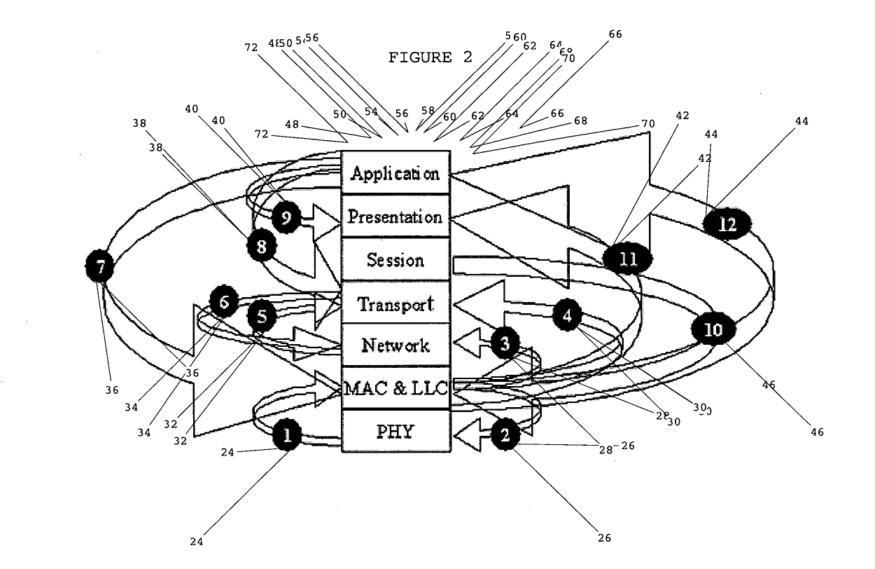

FIG. 2 is Cross-Layer interactions and feedback between all OSI mode seven layers for the optimization of the network, services, applications and user quality-of-experience

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A dynamic, integrated, multi-service network cross-layer optimization for a novel integrated approach in the optimization of the ip network parameters and resources such that the result would be a fundamentally and substantially more efficient and effective network, comprising:
means for provides the physical layer feedback to mac layer for link adaptation dynamically;
means for provides the mac layer feedback to phy layer for link adaptation parameter settings dynamically;
means for provides the mac layer feedback to ip layer for congestion or distortion based routing dynamically;
means for provides the mac layer feedback to the transport layer for protocol optimization dynamically;
means for provides the ip layer feedback to the transport layer for optimization such as congestion-distortion based scheduling dynamically;
means for provides the transport layer feedback to the ip layer for optimization such as setting the parameters for congestion-distortion based routing dynamically;
means for provides the applications layer feedback to the mac layer for application layer source encoding dynamically;
means for provides the applications layer feedback to the transport layer for application layer encoding and packetization dynamically;
means for provides the applications layer feedback to the presentation layer for application layer encryption & compression requirements dynamically;
means for provides the session layer feedback to the mac layer for session continuity such as in mobility and portability or multi-devices for the end-user;
means for provides the (mac) link layer feedback to the applications layer for optimizing the source encoding & packetization based on the airlink resources availability dynamically;
means for provides the (mac) link layer feedback to the presentation layer for optimizing the compression based on the airlink resources availability dynamically;
means for in a traditional ip network (such as a data-oriented wireline network), the 7 layers of the osi model are independent addressing the different functions performed. in a broadband wireless network however there is increasing need for coupling and feedback between the different layers of the osi model. the joint mac-phy layers optimization is now largely adopted in the broadband wireless ip networks standardization such as wimax and 3gpp.
the integrated network optimization is a comprehensive framework for a multi-variable optimization across all seven layers of the osi model, of the network resources and their allocations to optimally enable services to the end-users based on their slas.
therefore the application layer (layer 7) provides the application-specific requirements as in section 6 as constrained by the specific end-user profile and sla.
the presentation layer (layer 6), provides the compression & sla-specific encryption as in section 6 as constrained by the specific end-user profile and sla, as well as the compression algorithm and parameters as required for the delivery of the service and network optimization within the sla range.
the session layer (layer 5), provides the session setup, initiation and continuity, & the sla-specific mobility and portability as constrained by the specific end-user profile and sla, as well as the session continuity algorithms and parameters as required for the delivery of the service and network optimization within the sla range, and as the end-user is in the portable or mobile mode.
the transport layer (layer 4) provides the transport protocol optimization, control of the flows, and minimization of the congestions and distortions as required for the delivery of the service and network optimization within the sla range.
the network layer (layer 3) provides the qos parameters optimization, as well as ip-routing optimization for congestion and wireless channel degradation (as applicable) as required for the delivery of the service and network optimization within the sla range.
the mac layer (layer 2), provides the qos parameters optimization per the sla, in scheduling the traffic, as well as physical layer interfacing optimization for congestion and wireless channel degradation (as applicable) inclusive of partial link adaptation parameters optimization, as required for the delivery of the service and network optimization within the sla range.
the phy layer (layer 1) provides the partial link adaptation parameters optimization (such as adaptive modulation and coding, multi-antenna algorithms.), as well as mac layer interfacing optimization for and wireless channel degradation (as applicable) as required for the delivery of the service and network optimization within the sla range.
in a traditional ip network (such as a data-oriented wireline network), the 7 layers of the osi model are independent addressing the different functions performed. in a broadband wireless network however there is increasing need for coupling and feedback between the different layers of the osi model. the joint mac-phy layers optimization is now largely adopted in the broadband wireless ip networks standardization such as wimax and 3gpp.
with multiple services (multi-tier voip, video-o-ip, data,) over the broadband wireless ip networks, the need for these interactions between the various osi layers for an effective and efficient ip network with substantial multimedia traffic increases substantially.
an integrated approach to optimization involving all seven layers or a subset, for robust and resilient, high quality ip-based multimedia communication in a real-world network is the subject matter of this patent application. in a real-world network the links between the end-users and the access network node (base stations) compete for the network resources. specifically in a single base station area of coverage a multitude of end-users in the presence of varying multipath and interference compete for the network resources for that base station. in a real-world multi-base station the end-users associated with one base station also compete for network resources with the end-users of other base stations as well.
at the core of the network the sla-based delivery of the services (multiple to each end-user) requires management and optimization all the network resources. the dynamic integrated multi-service network optimization is the framework leveraging the capabilities of all seven layers of the osi model by fully exploiting the feedback and the interaction amongst these layers to achieve drastically improved levels of optimization;
means for an integrated optimization and its framework for a multi-service network whereby the network resources, their utilization, and their allocations are optimized;
means for an integrated optimization and its framework for a multi-service network whereby the network resources, their utilization, and their allocations are optimized reflecting the service-level agreements (slas) as constraints for the multi-variable optimization process;
means for an integrated optimization and its framework for an end-user utilizing one or more applications simultaneously, in a multi-service network whereby the network resources, their utilization, and their allocations are optimized, such that the one or more applications are compliant with the service-level agreement requirements inclusive of the service delivery of voip, video-o-ip, and data as such applications;
means for an integrated optimization and its framework for a multitude of users per the access node (such as a base station) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example);
means for an integrated optimization and its framework for a multitude of users per the access node with one or more tiers (such as a 3g or wimax base station or a wifi access point combined in a 2-tier wireless network) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example);
means for an integrated optimization and its framework for a multi-service ip-based wireless network whereby the wireless network resources, their utilization, and their allocations are optimized in the presence of link link-level degradations and the multiple-base stations interference;
means for an integrated optimization and its framework for video telephony in an ip-based wireless network whereby the wireless network resources, their utilization, and their allocations are optimized in the presence of link link-level degradations and the multiple-base stations interference. example include the cross-layer optimization including the source encoding, compression, congestion & distortion based scheduling, congestion & distortion based routing, and link layer link allocation, adaptation and optimization;
means for an integrated optimization and its framework for video multicast & broadcast in an ip-based wireless network whereby the wireless network resources, their utilization, and their allocations are optimized in the presence of link link-level degradations and the multiple-base stations interference. example include the cross-layer optimization including the source encoding, compression, congestion & distortion based scheduling, congestion & distortion based routing, and link layer link allocation, adaptation and optimization;
means for i. an integrated optimization and its framework for voip in an ip-based wireless network whereby the wireless network resources, their utilization, and their allocations are optimized in the presence of link link-level degradations and the multiple-base stations interference. example include the cross-layer optimization including the source encoding, compression, congestion & distortion based scheduling, congestion & distortion based routing, and link layer link allocation, adaptation and optimization;
means for an integrated optimization and its framework for video-o-ip (such as video telephony, video multicast, or iptv) for a multitude of users per the access node with one or more tiers (such as a 3g or wimax base station or a wifi access point combined in a 2-tier wireless network) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example);
means for an integrated optimization and its framework for mobility and portability management and session continuity (such as video telephony, video multicast, or iptv) for one or a multitude of users per the access node with one or more tiers (such as a 3g or wimax base station or a wifi access point combined in a 2-tier wireless network) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example); and
means for an integrated optimization and its framework for voice-o-ip for a multitude of users per the access node with one or more tiers (such as a 3g or wimax base station or a wifi access point combined in a 2-tier wireless network) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example).

2. The dynamic, integrated, multi-service network cross-layer optimization in accordance with claim 1, wherein said means for provides the physical layer feedback to mac layer for link adaptation dynamically comprises a 11-to-12 feedback.

3. The dynamic, integrated, multi-service network cross-layer optimization in accordance with claim 1, wherein said means for provides the mac layer feedback to phy layer for link adaptation parameter settings dynamically comprises a 12-to-11 feedback.

4. The dynamic, integrated, multi-service network cross-layer optimization in accordance with claim 1, wherein said means for provides the mac layer feedback to ip layer for congestion or distortion based routing dynamically comprises a 12-to-13 feedback.

5. The dynamic, integrated, multi-service network cross-layer optimization in accordance with claim 1, wherein said means for provides the mac layer feedback to the transport layer for protocol optimization dynamically comprises a 12-to-14 feedback.

6. The dynamic, integrated, multi-service network cross-layer optimization in accordance with claim 1, wherein said means for provides the ip layer feedback to the transport layer for optimization such as congestion-distortion based scheduling dynamically comprises a 13-to-14 feedback.

7. The dynamic, integrated, multi-service network cross-layer optimization in accordance with claim 1, wherein said means for provides the transport layer feedback to the ip layer for optimization such as setting the parameters for congestion-distortion based routing dynamically comprises a 14-to-13 feedback.

8. The dynamic, integrated, multi-service network cross-layer optimization in accordance with claim 1, wherein said means for provides the applications layer feedback to the mac layer for application layer source encoding dynamically comprises a 17-to-12 feedback.

9. The dynamic, integrated, multi-service network cross-layer optimization in accordance with claim 1, wherein said means for provides the applications layer feedback to the transport layer for application layer encoding and packetization dynamically comprises a 17-to-14 feedback.

10. The dynamic, integrated, multi-service network cross-layer optimization in accordance with claim 1, wherein said means for provides the applications layer feedback to the presentation layer for application layer encryption & compression requirements dynamically comprises a 17-to-16 feedback.

11. The dynamic, integrated, multi-service network cross-layer optimization in accordance with claim 1, wherein said means for provides the session layer feedback to the mac layer for session continuity such as in mobility and portability or multi-devices for the end-user comprises a 15-to-12 feedback.

12. The dynamic, integrated, multi-service network cross-layer optimization in accordance with claim 1, wherein said means for provides the (mac) link layer feedback to the applications layer for optimizing the source encoding & packetization based on the airlink resources availability dynamically comprises a 12-to-17 feedback.

13. The dynamic, integrated, multi-service network cross-layer optimization in accordance with claim 1, wherein said means for provides the (mac) link layer feedback to the presentation layer for optimizing the compression based on the airlink resources availability dynamically comprises a 12-to-16 feedback.

14. The dynamic, integrated, multi-service network cross-layer optimization in accordance with claim 1, wherein said means for in a traditional ip network (such as a data-oriented wireline network), the 7 layers of the osi model are independent addressing the different functions performed. in a broadband wireless network however there is increasing need for coupling and feedback between the different layers of the osi model. the joint mac-phy layers optimization is now largely adopted in the broadband wireless ip networks standardization such as wimax and 3gpp.
the integrated network optimization is a comprehensive framework for a multi-variable optimization across all seven layers of the osi model, of the network resources and their allocations to optimally enable services to the end-users based on their slas.
therefore the application layer (layer 7) provides the application-specific requirements as in section 6 as constrained by the specific end-user profile and sla.
the presentation layer (layer 6), provides the compression & sla-specific encryption as in section 6 as constrained by the specific end-user profile and sla, as well as the compression algorithm and parameters as required for the delivery of the service and network optimization within the sla range.
the session layer (layer 5), provides the session setup, initiation and continuity, & the sla-specific mobility and portability as constrained by the specific end-user profile and sla, as well as the session continuity algorithms and parameters as required for the delivery of the service and network optimization within the sla range, and as the end-user is in the portable or mobile mode.
the transport layer (layer 4) provides the transport protocol optimization, control of the flows, and minimization of the congestions and distortions as required for the delivery of the service and network optimization within the sla range.
the network layer (layer 3) provides the qos parameters optimization, as well as ip-routing optimization for congestion and wireless channel degradation (as applicable) as required for the delivery of the service and network optimization within the sla range.
the mac layer (layer 2), provides the qos parameters optimization per the sla, in scheduling the traffic, as well as physical layer interfacing optimization for congestion and wireless channel degradation (as applicable) inclusive of partial link adaptation parameters optimization, as required for the delivery of the service and network optimization within the sla range.
the phy layer (layer 1) provides the partial link adaptation parameters optimization (such as adaptive modulation and coding, multi-antenna algorithms.), as well as mac layer interfacing optimization for and wireless channel degradation (as applicable) as required for the delivery of the service and network optimization within the sla range.
in a traditional ip network (such as a data-oriented wireline network), the 7 layers of the osi model are independent addressing the different functions performed. in a broadband wireless network however there is increasing need for coupling and feedback between the different layers of the osi model. the joint mac-phy layers optimization is now largely adopted in the broadband wireless ip networks standardization such as wimax and 3gpp.
with multiple services (multi-tier voip, video-o-ip, data,) over the broadband wireless ip networks, the need for these interactions between the various osi layers for an effective and efficient ip network with substantial multimedia traffic increases substantially.
an integrated approach to optimization involving all seven layers or a subset, for robust and resilient, high quality ip-based multimedia communication in a real-world network is the subject matter of this patent application. in a real-world network the links between the end-users and the access network node (base stations) compete for the network resources. specifically in a single base station area of coverage a multitude of end-users in the presence of varying multipath and interference compete for the network resources for that base station. in a real-world multi-base station the end-users associated with one base station also compete for network resources with the end-users of other base stations as well.
at the core of the network the sla-based delivery of the services (multiple to each end-user) requires management and optimization all the network resources. the dynamic integrated multi-service network optimization is the framework leveraging the capabilities of all seven layers of the osi model by fully exploiting the feedback and the interaction amongst these layers to achieve drastically improved levels of optimization comprises a cross-layer optimization framework.

15. The dynamic, integrated, multi-service network cross-layer optimization in accordance with claim 1, wherein said means for an integrated optimization and its framework for a multi-service network whereby the network resources, their utilization, and their allocations are optimized comprises an integrated optimization framework.

16. The dynamic, integrated, multi-service network cross-layer optimization in accordance with claim 1, wherein said means for an integrated optimization and its framework for a multi-service network whereby the network resources, their utilization, and their allocations are optimized reflecting the service-level agreements (slas) as constraints for the multi-variable optimization process comprises a sla-based optimization framework.

17. The dynamic, integrated, multi-service network cross-layer optimization in accordance with claim 1, wherein said means for an integrated optimization and its framework for an end-user utilizing one or more applications simultaneously, in a multi-service network whereby the network resources, their utilization, and their allocations are optimized, such that the one or more applications are compliant with the service-level agreement requirements inclusive of the service delivery of voip, video-o-ip, and data as such applications comprises a multi-applications.

18. The dynamic, integrated, multi-service network cross-layer optimization in accordance with claim 1, wherein said means for an integrated optimization and its framework for a multitude of users per the access node (such as a base station) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example) comprises a multi-user framework.

19. The dynamic, integrated, multi-service network cross-layer optimization in accordance with claim 1, wherein said means for an integrated optimization and its framework for a multitude of users per the access node with one or more tiers (such as a 3g or wimax base station or a wifi access point combined in a 2-tier wireless network) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example) comprises a multi-tier wireless network.

20. The dynamic, integrated, multi-service network cross-layer optimization in accordance with claim 1, wherein said means for an integrated optimization and its framework for a multi-service ip-based wireless network whereby the wireless network resources, their utilization, and their allocations are optimized in the presence of link link-level degradations and the multiple-base stations interference comprises a wireless networks optimization framework.

21. The dynamic, integrated, multi-service network cross-layer optimization in accordance with claim 1, wherein said means for an integrated optimization and its framework for video telephony in an ip-based wireless network whereby the wireless network resources, their utilization, and their allocations are optimized in the presence of link link-level degradations and the multiple-base stations interference. example include the cross-layer optimization including the source encoding, compression, congestion & distortion based scheduling, congestion & distortion based routing, and link layer link allocation, adaptation and optimization comprises a video telephony framework.

22. The dynamic, integrated, multi-service network cross-layer optimization in accordance with claim 1, wherein said means for an integrated optimization and its framework for video multicast & broadcast in an ip-based wireless network whereby the wireless network resources, their utilization, and their allocations are optimized in the presence of link link-level degradations and the multiple-base stations interference. example include the cross-layer optimization including the source encoding, compression, congestion & distortion based scheduling, congestion & distortion based routing, and link layer link allocation, adaptation and optimization comprises a video multicast & broadcast.

23. The dynamic, integrated, multi-service network cross-layer optimization in accordance with claim 1, wherein said means for i. an integrated optimization and its framework for voip in an ip-based wireless network whereby the wireless network resources, their utilization, and their allocations are optimized in the presence of link link-level degradations and the multiple-base stations interference. example include the cross-layer optimization including the source encoding, compression, congestion & distortion based scheduling, congestion & distortion based routing, and link layer link allocation, adaptation and optimization comprises a voice-over-ip over wireless.

24. The dynamic, integrated, multi-service network cross-layer optimization in accordance with claim 1, wherein said means for an integrated optimization and its framework for video-o-ip (such as video telephony, video multicast, or iptv) for a multitude of users per the access node with one or more tiers (such as a 3g or wimax base station or a wifi access point combined in a 2-tier wireless network) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example) comprises a video-over-ip.

25. The dynamic, integrated, multi-service network cross-layer optimization in accordance with claim 1, wherein said means for an integrated optimization and its framework for mobility and portability management and session continuity (such as video telephony, video multicast, or iptv) for one or a multitude of users per the access node with one or more tiers (such as a 3g or wimax base station or a wifi access point combined in a 2-tier wireless network) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example) comprises a mobility/portability management.

26. The dynamic, integrated, multi-service network cross-layer optimization in accordance with claim 1, wherein said means for an integrated optimization and its framework for voice-o-ip for a multitude of users per the access node with one or more tiers (such as a 3g or wimax base station or a wifi access point combined in a 2-tier wireless network) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example) comprises a multi-user, multi-applications wireless networks.

27. A dynamic, integrated, multi-service network cross-layer optimization for a novel integrated approach in the optimization of the ip network parameters and resources such that the result would be a fundamentally and substantially more efficient and effective network, comprising:
a 11-to-12 feedback, for provides the physical layer feedback to mac layer for link adaptation dynamically;
a 12-to-11 feedback, for provides the mac layer feedback to phy layer for link adaptation parameter settings dynamically;
a 12-to-13 feedback, for provides the mac layer feedback to ip layer for congestion or distortion based routing dynamically;
a 12-to-14 feedback, for provides the mac layer feedback to the transport layer for protocol optimization dynamically;
a 13-to-14 feedback, for provides the ip layer feedback to the transport layer for optimization such as congestion-distortion based scheduling dynamically;
a 14-to-13 feedback, for provides the transport layer feedback to the ip layer for optimization such as setting the parameters for congestion-distortion based routing dynamically;
a 17-to-12 feedback, for provides the applications layer feedback to the mac layer for application layer source encoding dynamically;
a 17-to-14 feedback, for provides the applications layer feedback to the transport layer for application layer encoding and packetization dynamically;
a 17-to-16 feedback, for provides the applications layer feedback to the presentation layer for application layer encryption & compression requirements dynamically;
a 15-to-12 feedback, for provides the session layer feedback to the mac layer for session continuity such as in mobility and portability or multi-devices for the end-user;
a 12-to-17 feedback, for provides the (mac) link layer feedback to the applications layer for optimizing the source encoding & packetization based on the airlink resources availability dynamically;
a 12-to-16 feedback, for provides the (mac) link layer feedback to the presentation layer for optimizing the compression based on the airlink resources availability dynamically;
a cross-layer optimization framework, for in a traditional ip network (such as a data-oriented wireline network), the 7 layers of the osi model are independent addressing the different functions performed. in a broadband wireless network however there is increasing need for coupling and feedback between the different layers of the osi model. the joint mac-phy layers optimization is now largely adopted in the broadband wireless ip networks standardization such as wimax and 3gpp.
the integrated network optimization is a comprehensive framework for a multi-variable optimization across all seven layers of the osi model, of the network resources and their allocations to optimally enable services to the end-users based on their slas.
therefore the application layer (layer 7) provides the application-specific requirements as in section 6 as constrained by the specific end-user profile and sla.
the presentation layer (layer 6), provides the compression & sla-specific encryption as in section 6 as constrained by the specific end-user profile and sla, as well as the compression algorithm and parameters as required for the delivery of the service and network optimization within the sla range.
the session layer (layer 5), provides the session setup, initiation and continuity, & the sla-specific mobility and portability as constrained by the specific end-user profile and sla, as well as the session continuity algorithms and parameters as required for the delivery of the service and network optimization within the sla range, and as the end-user is in the portable or mobile mode.
the transport layer (layer 4) provides the transport protocol optimization, control of the flows, and minimization of the congestions and distortions as required for the delivery of the service and network optimization within the sla range.
the network layer (layer 3) provides the qos parameters optimization, as well as ip-routing optimization for congestion and wireless channel degradation (as applicable) as required for the delivery of the service and network optimization within the sla range.
the mac layer (layer 2), provides the qos parameters optimization per the sla, in scheduling the traffic, as well as physical layer interfacing optimization for congestion and wireless channel degradation (as applicable) inclusive of partial link adaptation parameters optimization, as required for the delivery of the service and network optimization within the sla range.
the phy layer (layer 1) provides the partial link adaptation parameters optimization (such as adaptive modulation and coding, multi-antenna algorithms.), as well as mac layer interfacing optimization for and wireless channel degradation (as applicable) as required for the delivery of the service and network optimization within the sla range.
in a traditional ip network (such as a data-oriented wireline network), the 7 layers of the osi model are independent addressing the different functions performed. in a broadband wireless network however there is increasing need for coupling and feedback between the different layers of the osi model. the joint mac-phy layers optimization is now largely adopted in the broadband wireless ip networks standardization such as wimax and 3gpp.
with multiple services (multi-tier voip, video-o-ip, data,) over the broadband wireless ip networks, the need for these interactions between the various osi layers for an effective and efficient ip network with substantial multimedia traffic increases substantially.
an integrated approach to optimization involving all seven layers or a subset, for robust and resilient, high quality ip-based multimedia communication in a real-world network is the subject matter of this patent application. in a real-world network the links between the end-users and the access network node (base stations) compete for the network resources. specifically in a single base station area of coverage a multitude of end-users in the presence of varying multipath and interference compete for the network resources for that base station. in a real-world multi-base station the end-users associated with one base station also compete for network resources with the end-users of other base stations as well.
at the core of the network the sla-based delivery of the services (multiple to each end-user) requires management and optimization all the network resources. the dynamic integrated multi-service network optimization is the framework leveraging the capabilities of all seven layers of the osi model by fully exploiting the feedback and the interaction amongst these layers to achieve drastically improved levels of optimization;
an integrated optimization framework, for an integrated optimization and its framework for a multi-service network whereby the network resources, their utilization, and their allocations are optimized;
a sla-based optimization framework, for an integrated optimization and its framework for a multi-service network whereby the network resources, their utilization, and their allocations are optimized reflecting the service-level agreements (slas) as constraints for the multi-variable optimization process;
a multi-applications, for an integrated optimization and its framework for an end-user utilizing one or more applications simultaneously, in a multi-service network whereby the network resources, their utilization, and their allocations are optimized, such that the one or more applications are compliant with the service-level agreement requirements inclusive of the service delivery of voip, video-o-ip, and data as such applications;
a multi-user framework, for an integrated optimization and its framework for a multitude of users per the access node (such as a base station) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example);
a multi-tier wireless network, for an integrated optimization and its framework for a multitude of users per the access node with one or more tiers (such as a 3g or wimax base station or a wifi access point combined in a 2-tier wireless network) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example);
a wireless networks optimization framework, for an integrated optimization and its framework for a multi-service ip-based wireless network whereby the wireless network resources, their utilization, and their allocations are optimized in the presence of link link-level degradations and the multiple-base stations interference;
a video telephony framework, for an integrated optimization and its framework for video telephony in an ip-based wireless network whereby the wireless network resources, their utilization, and their allocations are optimized in the presence of link link-level degradations and the multiple-base stations interference. example include the cross-layer optimization including the source encoding, compression, congestion & distortion based scheduling, congestion & distortion based routing, and link layer link allocation, adaptation and optimization;
a video multicast & broadcast, for an integrated optimization and its framework for video multicast & broadcast in an ip-based wireless network whereby the wireless network resources, their utilization, and their allocations are optimized in the presence of link link-level degradations and the multiple-base stations interference. example include the cross-layer optimization including the source encoding, compression, congestion & distortion based scheduling, congestion & distortion based routing, and link layer link allocation, adaptation and optimization;
a voice-over-ip over wireless, for i. an integrated optimization and its framework for voip in an ip-based wireless network whereby the wireless network resources, their utilization, and their allocations are optimized in the presence of link link-level degradations and the multiple-base stations interference. example include the cross-layer optimization including the source encoding, compression, congestion & distortion based scheduling, congestion & distortion based routing, and link layer link allocation, adaptation and optimization;
a video-over-ip, for an integrated optimization and its framework for video-o-ip (such as video telephony, video multicast, or iptv) for a multitude of users per the access node with one or more tiers (such as a 3g or wimax base station or a wifi access point combined in a 2-tier wireless network) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example);
a mobility/portability management, for an integrated optimization and its framework for mobility and portability management and session continuity (such as video telephony, video multicast, or iptv) for one or a multitude of users per the access node with one or more tiers (such as a 3g or wimax base station or a wifi access point combined in a 2-tier wireless network) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example); and
a multi-user, multi-applications wireless networks, for an integrated optimization and its framework for voice-o-ip for a multitude of users per the access node with one or more tiers (such as a 3g or wimax base station or a wifi access point combined in a 2-tier wireless network) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example).

28. A dynamic, integrated, multi-service network cross-layer optimization for a novel integrated approach in the optimization of the ip network parameters and resources such that the result would be a fundamentally and substantially more efficient and effective network, comprising:
a 11-to-12 feedback, for provides the physical layer feedback to mac layer for link adaptation dynamically;
a 12-to-11 feedback, for provides the mac layer feedback to phy layer for link adaptation parameter settings dynamically;
a 12-to-13 feedback, for provides the mac layer feedback to ip layer for congestion or distortion based routing dynamically;
a 12-to-14 feedback, for provides the mac layer feedback to the transport layer for protocol optimization dynamically;
a 13-to-14 feedback, for provides the ip layer feedback to the transport layer for optimization such as congestion-distortion based scheduling dynamically;
a 14-to-13 feedback, for provides the transport layer feedback to the ip layer for optimization such as setting the parameters for congestion-distortion based routing dynamically;
a 17-to-12 feedback, for provides the applications layer feedback to the mac layer for application layer source encoding dynamically;
a 17-to-14 feedback, for provides the applications layer feedback to the transport layer for application layer encoding and packetization dynamically;
a 17-to-16 feedback, for provides the applications layer feedback to the presentation layer for application layer encryption & compression requirements dynamically;
a 15-to-12 feedback, for provides the session layer feedback to the mac layer for session continuity such as in mobility and portability or multi-devices for the end-user;
a 12-to-17 feedback, for provides the (mac) link layer feedback to the applications layer for optimizing the source encoding & packetization based on the airlink resources availability dynamically;
a 12-to-16 feedback, for provides the (mac) link layer feedback to the presentation layer for optimizing the compression based on the airlink resources availability dynamically;
a cross-layer optimization framework, for in a traditional ip network (such as a data-oriented wireline network), the 7 layers of the osi model are independent addressing the different functions performed. in a broadband wireless network however there is increasing need for coupling and feedback between the different layers of the osi model. the joint mac-phy layers optimization is now largely adopted in the broadband wireless ip networks standardization such as wimax and 3gpp.
the integrated network optimization is a comprehensive framework for a multi-variable optimization across all seven layers of the osi model, of the network resources and their allocations to optimally enable services to the end-users based on their slas.
therefore the application layer (layer 7) provides the application-specific requirements as in section 6 as constrained by the specific end-user profile and sla.
the presentation layer (layer 6), provides the compression & sla-specific encryption as in section 6 as constrained by the specific end-user profile and sla, as well as the compression algorithm and parameters as required for the delivery of the service and network optimization within the sla range.
the session layer (layer 5), provides the session setup, initiation and continuity, & the sla-specific mobility and portability as constrained by the specific end-user profile and sla, as well as the session continuity algorithms and parameters as required for the delivery of the service and network optimization within the sla range, and as the end-user is in the portable or mobile mode.
the transport layer (layer 4) provides the transport protocol optimization, control of the flows, and minimization of the congestions and distortions as required for the delivery of the service and network optimization within the sla range.
the network layer (layer 3) provides the qos parameters optimization, as well as ip-routing optimization for congestion and wireless channel degradation (as applicable) as required for the delivery of the service and network optimization within the sla range.
the mac layer (layer 2), provides the qos parameters optimization per the sla, in scheduling the traffic, as well as physical layer interfacing optimization for congestion and wireless channel degradation (as applicable) inclusive of partial link adaptation parameters optimization, as required for the delivery of the service and network optimization within the sla range.
the phy layer (layer 1) provides the partial link adaptation parameters optimization (such as adaptive modulation and coding, multi-antenna algorithms.), as well as mac layer interfacing optimization for and wireless channel degradation (as applicable) as required for the delivery of the service and network optimization within the sla range.
in a traditional ip network (such as a data-oriented wireline network), the 7 layers of the osi model are independent addressing the different functions performed. in a broadband wireless network however there is increasing need for coupling and feedback between the different layers of the osi model. the joint mac-phy layers optimization is now largely adopted in the broadband wireless ip networks standardization such as wimax and 3gpp.
with multiple services (multi-tier voip, video-o-ip, data,) over the broadband wireless ip networks, the need for these interactions between the various osi layers for an effective and efficient ip network with substantial multimedia traffic increases substantially.
an integrated approach to optimization involving all seven layers or a subset, for robust and resilient, high quality ip-based multimedia communication in a real-world network is the subject matter of this patent application. in a real-world network the links between the end-users and the access network node (base stations) compete for the network resources. specifically in a single base station area of coverage a multitude of end-users in the presence of varying multipath and interference compete for the network resources for that base station. in a real-world multi-base station the end-users associated with one base station also compete for network resources with the end-users of other base stations as well.
at the core of the network the sla-based delivery of the services (multiple to each end-user) requires management and optimization all the network resources. the dynamic integrated multi-service network optimization is the framework leveraging the capabilities of all seven layers of the osi model by fully exploiting the feedback and the interaction amongst these layers to achieve drastically improved levels of optimization;
an integrated optimization framework, for an integrated optimization and its framework for a multi-service network whereby the network resources, their utilization, and their allocations are optimized;
a sla-based optimization framework, for an integrated optimization and its framework for a multi-service network whereby the network resources, their utilization, and their allocations are optimized reflecting the service-level agreements (slas) as constraints for the multi-variable optimization process;
a multi-applications, for an integrated optimization and its framework for an end-user utilizing one or more applications simultaneously, in a multi-service network whereby the network resources, their utilization, and their allocations are optimized, such that the one or more applications are compliant with the service-level agreement requirements inclusive of the service delivery of voip, video-o-ip, and data as such applications;
a multi-user framework, for an integrated optimization and its framework for a multitude of users per the access node (such as a base station) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example);
a multi-tier wireless network, for an integrated optimization and its framework for a multitude of users per the access node with one or more tiers (such as a 3g or wimax base station or a wifi access point combined in a 2-tier wireless network) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example);
a wireless networks optimization framework, for an integrated optimization and its framework for a multi-service ip-based wireless network whereby the wireless network resources, their utilization, and their allocations are optimized in the presence of link link-level degradations and the multiple-base stations interference;
a video telephony framework, for an integrated optimization and its framework for video telephony in an ip-based wireless network whereby the wireless network resources, their utilization, and their allocations are optimized in the presence of link link-level degradations and the multiple-base stations interference. example include the cross-layer optimization including the source encoding, compression, congestion & distortion based scheduling, congestion & distortion based routing, and link layer link allocation, adaptation and optimization;
a video multicast & broadcast, for an integrated optimization and its framework for video multicast & broadcast in an ip-based wireless network whereby the wireless network resources, their utilization, and their allocations are optimized in the presence of link link-level degradations and the multiple-base stations interference. example include the cross-layer optimization including the source encoding, compression, congestion & distortion based scheduling, congestion & distortion based routing, and link layer link allocation, adaptation and optimization;
a voice-over-ip over wireless, for i. an integrated optimization and its framework for voip in an ip-based wireless network whereby the wireless network resources, their utilization, and their allocations are optimized in the presence of link link-level degradations and the multiple-base stations interference. example include the cross-layer optimization including the source encoding, compression, congestion & distortion based scheduling, congestion & distortion based routing, and link layer link allocation, adaptation and optimization;
a video-over-ip, for an integrated optimization and its framework for video-o-ip (such as video telephony, video multicast, or iptv) for a multitude of users per the access node with one or more tiers (such as a 3g or wimax base station or a wifi access point combined in a 2-tier wireless network) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example);
a mobility/portability management, for an integrated optimization and its framework for mobility and portability management and session continuity (such as video telephony, video multicast, or iptv) for one or a multitude of users per the access node with one or more tiers (such as a 3g or wimax base station or a wifi access point combined in a 2-tier wireless network) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example); and
a multi-user, multi-applications wireless networks, for an integrated optimization and its framework for voice-o-ip for a multitude of users per the access node with one or more tiers (such as a 3g or wimax base station or a wifi access point combined in a 2-tier wireless network) in a multi-service network whereby the network resources, their utilization, and their allocations are optimized incorporating the dynamic traffic associated with one or more application for each end-user simultaneously, and the dynamic traffic associated with the aggregate of these end-users associated with one or more access modes (base stations for example).
